(19) United States
(12) Patent Application Publication
(10) Pub. No.: US 2025/0347365 A1
(43) Pub. Date: Nov. 13, 2025

(54) METHOD OF JOINING DISSIMILAR MATERIAL PIPES AND DISSIMILAR MATERIAL PIPE

(71) Applicants: HYUNDAI MOTOR COMPANY, SEOUL (KR); KIA CORPORATION, SEOUL (KR)

(72) Inventors: In-Beom Lee, Hwaseong-si (KR); Jae-Hong Park, Hwaseong-si (KR); Hyun-Min Sung, Hwaseong-si (KR)

(73) Assignees: HYUNDAI MOTOR COMPANY, SEOUL (KR); KIA CORPORATION, SEOUL (KR)

(21) Appl. No.: 18/822,902

(22) Filed: Sep. 3, 2024

(30) Foreign Application Priority Data
May 8, 2024 (KR) 10-2024-0060482

(51) Int. Cl. F16L 13/00; F16L 9/147; F16L 13/14

(52) U.S. Cl. CPC F16L 13/004; F16L 9/147; F16L 13/141

(57) ABSTRACT

A method of joining dissimilar material pipes includes inserting an end portion of a first pipe into a heat shrink tube, performing heat treatment on the first pipe joined to the heat shrink tube to shrink the heat shrink tube, press-inserting the end portion of the first pipe to which the heat shrink tube is joined into a second pipe, and plastic deforming and joining a plastic deformation portion where the first pipe, the second pipe, and the heat shrink tube overlap. The joined dissimilar material pipes have improved airtightness and can operate at a high pressure and an extremely low temperature.

### CROSS REFERENCE TO RELATED APPLICATIONS

This application claims priority to Korean Patent Application No. 10-2024-0060482, filed on May 8, 2024, which is incorporated herein by reference in its entirety.

### BACKGROUND

### Field of Present Disclosure

Exemplary embodiments of the present disclosure relate to a method of joining dissimilar material pipes and joined dissimilar material pipe.

### Description of Related Art

In the case of piping for fluid transport and the like, it is necessary to connect dissimilar material pipes as necessary, for example, in the case of piping for liquefied hydrogen storage containers.

The need for application of liquefied hydrogen is increasing due to a high volumetric energy density compared to the existing gaseous hydrogen, and when the liquefied hydrogen is supplied to a fuel cell system, the liquefied hydrogen is converted into gaseous hydrogen through a heat exchanger before being supplied.

Here, joining pipes at a connection between a stainless steel (SUS) material of a hydrogen storage container and an Al material of the heat exchanger is essential, and in the related art, rotational friction welding (RFW) is applied to join these dissimilar material pipes.

However, since the RFW is a joining method by applying a rotation and a pressure, each pipe requires a predetermined thickness or more so that an increase in weight and size is inevitable.

In addition, there is a risk of poor quality due to cracks occurring in a joint portion, and there is also a risk of galvanic corrosion occurring due to a contact between dissimilar materials.

In the related art, there is a method of fitting two pipes using a joint portion between dissimilar material pipes, but it is difficult for the method to apply to a hard material such as a steel, and a fastening member remains intact even after fastening.

In addition, there is a method of joining two parts by welding and molding using electromagnetic pulses and the like, but joining through such welding has a high probability of poor quality and difficulty in securing airtightness.

The contents described in the above Description of Related Art are to aid understanding of the background of the present disclosure and may include what is not previously known to those skilled in the art to which the present disclosure pertains.

### SUMMARY

An embodiment of the present disclosure is directed to providing a method of joining dissimilar material pipes, which has excellent airtightness and can operate even at a high pressure and an extremely low temperature, and dissimilar material pipes.

Other objects and advantages of the present disclosure can be understood by the following description and become apparent with reference to the embodiments of the present disclosure. Also, it is obvious to those skilled in the art to which the present disclosure pertains that the objects and advantages of the present disclosure can be realized by the means as claimed and combinations thereof.

In accordance with an embodiment of the present disclosure, there is provided a method of joining dissimilar material pipes, which includes inserting an end portion of a first pipe into a heat shrink tube, performing heat treatment on the first pipe joined to the heat shrink tube to shrink the heat shrink tube, press-inserting the end portion of the first pipe to which the heat shrink tube is joined into a second pipe, and plastic deforming and joining a plastic deformation portion where the first pipe, the second pipe, and the heat shrink tube overlap.

Here, the first pipe and the second pipe may be made of dissimilar materials.

In addition, the first pipe and the second pipe may not be in direct contact with each other.

In addition, the heat shrink tube may be made of one of polytetrafluoroethylene (PTFE), polychlorotrifluoroethylene (PCTFE), ultra-high molecular weight polyethylene (UHMW PE), or PolyMide.

Meanwhile, in the shrinking of the heat shrink tube, heat treatment may be performed in a temperature condition ranging from 100° C. to 400° C.

Furthermore, the joining operation may include arranging an assembly of the first pipe, the second pipe, and the heat shrink tube between a plurality of jigs of a rotary swaging device, and operating the rotary swaging device and pressing, by the jigs, the assembly in a radial direction.

In addition, a side surface of a pressing portion of the jig may have a tapered shape, and a curvature of a bent portion between a bottom surface and the side surface of the jig may be 60 ϕ [mm] or less.

In addition, the first pipe may be made of Al and may be a pipe on a heat exchanger of a liquefied hydrogen system, and the second pipe may be made of a steel and may be a pipe on a liquefied hydrogen storage container of the liquefied hydrogen system.

In accordance with another embodiment of the present disclosure, there is provided a dissimilar material pipe including a first pipe, a heat shrink tube into which an end portion of the first pipe is inserted, and a second pipe into which the end portion of the first pipe coupled to the heat shrink tube is press-inserted, wherein a plastic deformation portion where the first pipe, the second pipe, and the heat shrink tube overlap is plastic-deformed and joined.

Herein, the heat shrink tube may be shrunk by heat treatment and joined to the first pipe.

In addition, the first pipe and the second pipe may be made of dissimilar materials.

In addition, the first pipe and the second pipe may not be in direct contact with each other.

Furthermore, the heat shrink tube may be made of one of polytetrafluoroethylene (PTFE), polychlorotrifluoroethylene (PCTFE), ultra-high molecular weight polyethylene (UHMW PE), or PolyMide.

In addition, the plastic deformation portion may be plastic deformed by press in a radial direction.

Meanwhile, the first pipe may be made of Al and may be a pipe on a heat exchanger of a liquefied hydrogen system, and the second pipe may be made of a steel and may be a pipe on a liquefied hydrogen storage container of the liquefied hydrogen system.

### BRIEF DESCRIPTION OF THE FIGURES

FIGS. 1, 2, 3, and 4 are diagrams sequentially illustrating a method of joining dissimilar material pipes of the present disclosure.

FIG. 5 is a diagram illustrating a portion of a jig for the method of joining dissimilar material pipes of the present disclosure.

FIG. 6 is a diagram illustrating dissimilar material pipes joined by the method of joining dissimilar material pipes of the present disclosure.

### DETAILED DESCRIPTION

In order to fully understand the present disclosure and operational advantages of the present disclosure and objects attained by practicing the present disclosure, reference should be made to the accompanying drawings that illustrate exemplary embodiments of the present disclosure and to the description in the accompanying drawings.

In describing exemplary embodiments of the present disclosure, known technologies or repeated descriptions may be reduced or omitted to avoid unnecessarily obscuring the gist of the present disclosure.

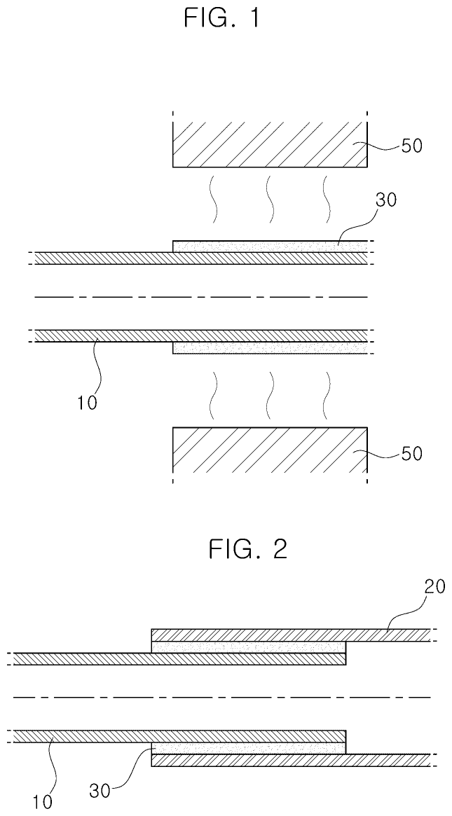

FIGS. 1 to 4 are diagrams sequentially illustrating a method of joining dissimilar material pipes of the present disclosure.

Hereinafter, the method of joining dissimilar material pipes and a dissimilar material pipe according to one embodiment of the present disclosure will be described with reference to FIGS. 1 to 4.

The present disclosure relates to a method of manufacturing one part by joining two dissimilar material pipes and is applicable to a pipe or shaft.

For example, the pipe may be a pipe that effectively connects a fuel cell electric vehicle (FCEV) liquefied hydrogen storage container and a heat exchanger. In this case, a first pipe 10 made of an Al material may be a pipe at a heat exchanger, and a second pipe 20 made of a steel may be a pipe at a hydrogen storage container.

First, the first pipe 10 may be an extruded material of 6000 series Al, and a heat shrink tube 30, which has an inner diameter corresponding to an outer diameter of the first pipe 10 and has a length corresponding to a plastic deformation portion of the first pipe 10, is inserted.

The heat shrink tube 30, which also serves as a sealing member, may be made of polytetrafluoroethylene (PTFE), polychlorotrifluoroethylene (PCTFE), ultra-high molecular weight polyethylene (UHMW PE), or PolyMide, which is usable at a minimum temperature of −253° C.

Then, heat treatment is performed on the heat shrink tube 30 by a heat treatment apparatus 50 in a condition at a temperature ranging from 100° C. to 400° C.

This is a temperature condition considering a material of the heat shrink tube, and thus the heat shrink tube 30 is allowed to be shrunk and joined to the first pipe 10. Airtightness may be secured by the heat shrink tube 30.

Then, the first pipe 10+heat shrink tube 30 is press-inserted into the first pipe 10, which has an outer diameter of the shrunk heat shrink tube 30, and the dissimilar material second pipe 20. A press-inserted length corresponds to a length of the heat shrink tube 30, and the second pipe 20 may be a stainless steel (SUS) pipe. In this way, according to the present disclosure, since the first pipe 10 and the second pipe 20 are not in direct contact (contactless), galvanic corrosion can be prevented.

According to the present disclosure, the dissimilar material pipes are joined through a rotary swaging process. The rotary swaging process is a forging process of forming a shaft toward the center thereof through rotational pressing and is mainly applied to a thin and multi-stage shaft product.

Therefore, next, the plastic deformation portion of the first pipe 10+second pipe 20+heat shrink tube 30, which is prepared as above, is disposed between a plurality of jigs 40 of a rotary swaging device.

When the rotary swaging device is operated, a hammer operated by a pressure roller rotating outside the jigs 40 presses the jigs 40, and the jigs 40 presses an outer surface of an assembly in a radial direction, causing plastic deformation of the assembly and joining the assembly.

For example, the assembly may be plastic deformed due to rotating and pressing at a roller speed of 1200 rpm, a hammer speed of 500 rpm, and a jig speed of 200 rpm.

In this way, according to the present disclosure, quality defects and durability degradation due to heat can be removed through weldingless joining.

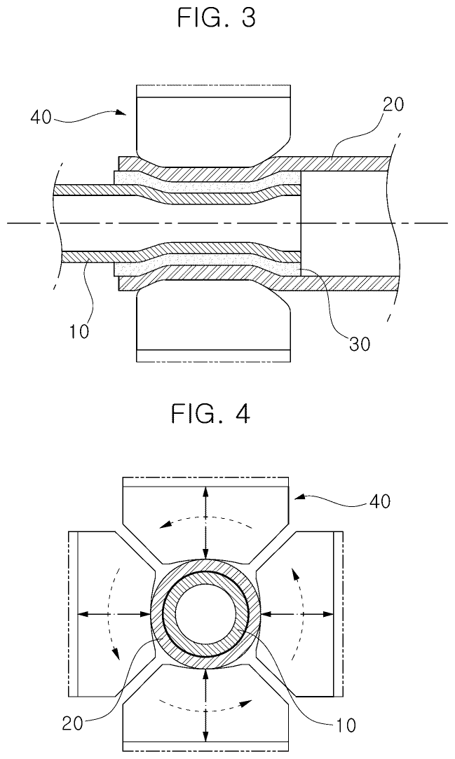

FIG. 5 shows a pressing portion of the jig of the rotary swaging device.

For example, a length of the jig may be 100 mm or less and a height thereof may be 5 mm or less.

For smooth pressing and quality of the plastic deformation portion, it is desirable for a side surface of the pressing portion to have a tapered shape.

Therefore, an angle shown in the drawing is preferably 80° or less, a bottom surface and side surfaces are connected in a curved manner, and in this case, a curvature R is preferably 60 ϕmm or less (a curved surface of 60 mm or less).

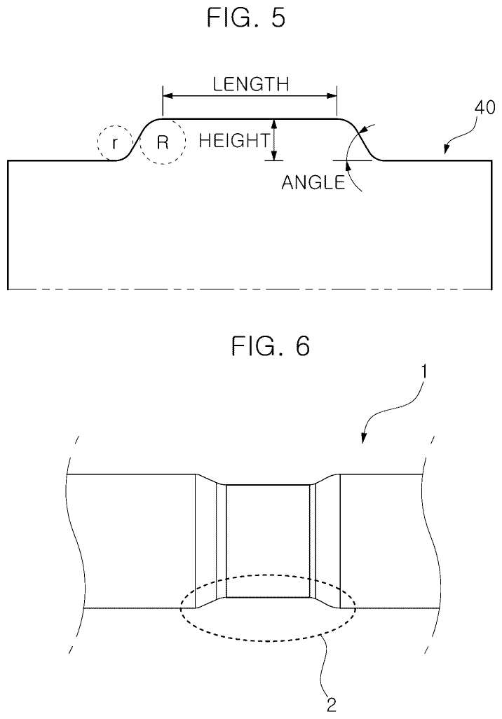

Due to a shape of the pressing portion of the jig, a plastic deformation portion 2 of a dissimilar material pipe 1 is plastically deformed and joined as shown in FIG. 6.

In the related art, there is restriction on a thickness of a pipe, but according to the present disclosure, there is fewer restriction on a thickness of a pipe by geometrically joining pipes through plastic deformation.

In addition, in the case of conventional welding, there is a risk of poor quality and durability degradation, but according to the present disclosure, there is no poor quality and durability degradation due to heat through weldingless joining.

In addition, galvanic corrosion can be prevented by preventing a contact between dissimilar materials through application of a sealing member.

Therefore, according to the present disclosure, it is possible to manufacture a dissimilar material (SUS-Al) joined pipe that can operate even at a high pressure and an extremely low temperature, and airtightness which is the most important characteristic can be secured through application of a sealing member.

Therefore, a fuel cell electric vehicle (FCEV) liquefied hydrogen storage container and a heat exchanger can be effectively connected.

While the present disclosure has been described with reference to the accompanying drawings, it will be apparent to those skilled in the art that various changes and modifications can be made without departing from the spirit and scope of the present disclosure without being limited to the exemplary embodiments disclosed herein. Accordingly, it should be noted that such alternations or modifications fall within the claims of the present disclosure, and the scope of the present disclosure should be construed on the basis of the appended claims.

1. A method of joining pipes made of dissimilar material, comprising:
inserting an end portion of a first pipe into a heat shrink tube;
performing heat treatment on the first pipe joined to the heat shrink tube to shrink the heat shrink tube;
press-inserting the end portion of the first pipe to which the heat shrink tube is joined into a second pipe; and
plastic deforming and joining a plastic deformation portion where the first pipe, the second pipe, and the heat shrink tube overlap.

2. The method of claim 1, wherein the first pipe and the second pipe are made of dissimilar materials.

3. The method of claim 1, wherein the first pipe and the second pipe are not in direct contact with each other.

4. The method of claim 1, wherein the heat shrink tube is made of one of polytetrafluoroethylene (PTFE), polychlorotrifluoroethylene (PCTFE), ultra-high molecular weight polyethylene (UHMW PE), or PolyMide.

5. The method of claim 4, wherein, in the shrinking of the heat shrink tube, the heat treatment is performed in a temperature condition ranging from 100° C. to 400° C.

6. The method of claim 1, wherein the joining operation includes:
arranging an assembly of the first pipe, the second pipe, and the heat shrink tube between a plurality of jigs of a rotary swaging device; and
operating the rotary swaging device and pressing, by the jigs, the assembly in a radial direction.

7. The method of claim 6, wherein:
a side surface of a pressing portion of the jig has a tapered shape; and
a curvature of a bent portion between a bottom surface and the side surface of the jig is 60 ϕ mm or less.

8. The method of claim 1, wherein the first pipe is made of Al and is a pipe on a heat exchanger of a liquefied hydrogen system, and the second pipe is made of a steel and is a pipe on a liquefied hydrogen storage container of the liquefied hydrogen system.

9. A dissimilar material pipe, comprising:
a first pipe;
a heat shrink tube into which an end portion of the first pipe is inserted; and
a second pipe into which the end portion of the first pipe coupled to the heat shrink tube is press-inserted;
wherein a plastic deformation portion where the first pipe, the second pipe, and the heat shrink tube overlap is plastic-deformed and joined.

10. The dissimilar material pipe of claim 9, wherein the heat shrink tube is shrunk by heat treatment and joined to the first pipe.

11. The dissimilar material pipe of claim 9, wherein the first pipe and the second pipe are made of dissimilar materials.

12. The dissimilar material pipe of claim 9, wherein the first pipe and the second pipe are not in direct contact with each other.

13. The dissimilar material pipe of claim 9, wherein the heat shrink tube is made of one of polytetrafluoroethylene (PTFE), polychlorotrifluoroethylene (PCTFE), ultra-high molecular weight polyethylene (UHMW PE), or PolyMide.

14. The dissimilar material pipe of claim 9, wherein the plastic deformation portion is deformed by pressing in a radial direction.

15. The dissimilar material pipe of claim 9, wherein the first pipe is made of Al and is a pipe on a heat exchanger of a liquefied hydrogen system, and the second pipe is made of a steel and is a pipe on a liquefied hydrogen storage container of the liquefied hydrogen system.
